(19) United States
(12) Patent Application Publication
(10) Pub. No.: US 2024/0397843 A1
(43) Pub. Date: Dec. 5, 2024

(54) OUTDOOR GARDENING TOOLS

(71) Applicant: Milwaukee Electric Tool Corporation, Brookfield, WI (US)

(72) Inventors: Joe Wilinski, Brookfield, WI (US); Kyle Reeder, Brookfield, WI (US); Michael Van Dyke, Wauwatosa, WI (US); Keith Grider, Brookfield, WI (US)

(21) Appl. No.: 18/680,035

(22) Filed: May 31, 2024

Related U.S. Application Data
(60) Provisional application No. 63/470,620, filed on Jun. 2, 2023.

(51) Int. Cl. A01B 1/22; A01B 1/16; A01B 1/20

(52) U.S. Cl. CPC A01B 1/22; A01B 1/165; A01B 1/20

(57) ABSTRACT

Outdoor gardening tools are provided. An outdoor tool includes a powerhead unit and a tool unit powered by the powerhead unit. The tool further includes a user control member, and a grip member. The tool unit includes an elongated body having a shaft and a cutting element extending radially from the shaft, and a connector. The connector is configured to couple with a complementary connector of the powerhead. The tool unit is configured to be rotatably driven by the powerhead. The tool is configured to enable a user to dig a hole in a ground surface while maintaining a standing position.

### CROSS-REFERENCE TO RELATED APPLICATIONS

The present application claims priority to U.S. Provisional Patent Application No. 63/470,620 filed on Jun. 2, 2023, the disclosure of which is incorporated by reference herein in its entirety.

### FIELD

The present disclosure relates generally to outdoor gardening tools.

### BACKGROUND

Gardening is a beloved pastime enjoyed by millions worldwide, offering numerous benefits such as stress relief, physical exercise, and connection with nature. However, gardening can also impose significant physical strain on individuals, particularly due to the repetitive tasks involved and the need for prolonged periods of bending over and standing up.

One of the primary challenges in traditional gardening is the ergonomic inefficiency of conventional garden tools. Many existing tools lack ergonomic design features, leading to discomfort, fatigue, and even injury among users. For example, small holes must be dug out of the ground repeatedly when planting a garden. Digging can be a strain intensive task, particularly when an individual is bent over or crouched down to dig a small hole in the ground. Similarly, it may be strenuous to continually get up and down to place plants in a defined garden bed. The repetitive nature of these tasks such as digging, weeding, and planting can exacerbate musculoskeletal strain and fatigue, especially in the back, shoulders, and wrists.

Accordingly, improved outdoor gardening tools are desired in the art. In particular, outdoor gardening tools which provide improve both ergonomics and efficiency for tasks such as digging and planting would be advantageous.

### BRIEF DESCRIPTION

Aspects and advantages of the present disclosure will be set forth in part in the following description, or may be obvious from the description, or may be learned through practice of the technology.

In accordance with one embodiment, an outdoor tool is provided. The outdoor tool includes a powerhead unit and a tool unit powered by the powerhead unit. The tool further includes a user control member, and a grip member. The tool unit includes an elongated body having a shaft and a cutting element extending radially from the shaft, and a connector. The connector is configured to couple with a complementary connector of the powerhead. The tool unit is configured to be rotatably driven by the powerhead. The tool is configured to enable a user to dig a hole in a ground surface while maintaining a standing position.

These and other features, aspects and advantages of the present disclosure will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present application, including the best mode of making and using the present systems and methods, directed to one of ordinary skill in the art, is set forth in the specification, which makes reference to the appended figures, in which:

FIG. 1 is a perspective view of an outdoor garden tool in accordance with embodiments of the present disclosure;

FIGS. 2A-2H illustrate alternative tool units for use with the powerhead of FIG. 1 in accordance with embodiments of the present disclosure;

FIG. 3A is a perspective view of an outdoor garden tool in accordance with embodiments of the present disclosure;

FIG. 3B is an outdoor garden tool in accordance with embodiments of the present disclosure;

FIG. 4A is a perspective view of an outdoor garden tool in accordance with embodiments of the present disclosure;

FIG. 4B is a schematic illustration of steps of use of the garden tool of FIG. 4A in accordance with embodiments of the present disclosure;

FIG. 5 is a front view of an outdoor garden tool being extended from a compressed to an extended configuration in accordance with embodiments of the present disclosure.

### DETAILED DESCRIPTION

Reference now will be made in detail to embodiments of the present disclosure, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the disclosure.

As used herein, the terms “first”, “second”, and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising.” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present). A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counter-clockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

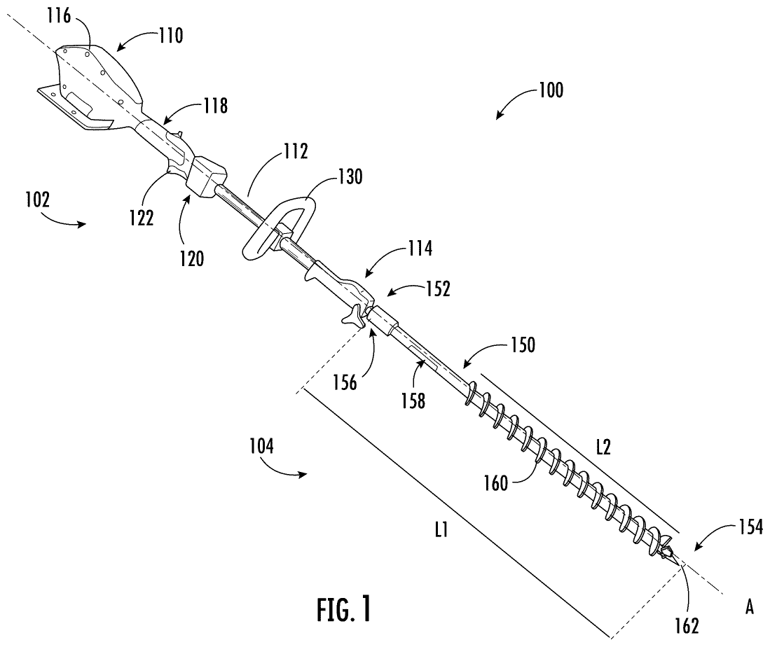

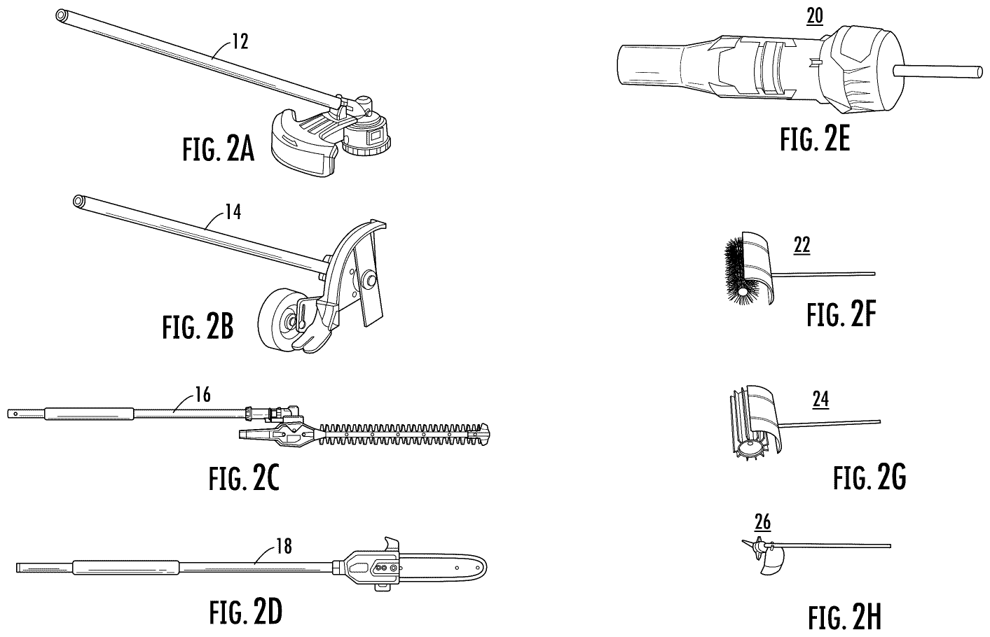

Referring now to the drawings, FIG. 1 illustrates an outdoor garden tool 100. The outdoor garden tool 100 includes a powerhead unit 102 and a tool unit 104 coupled to the powerhead unit 102. In the example illustrated in FIG. 1, the tool unit 104 comprises an auger, to be described in further detail below. In other constructions, such as those illustrated in FIGS. 2A-2H, the tool unit 104 may include a string trimmer 12, an edger 14, a hedge trimmer 16, a pole saw 18, a blower 20, a rotating brush 22, a rotating broom 24, or a brush cutter 26. In further constructions (not shown), the tool unit may include another tool attachment (e.g., a cultivator attachment, a saw attachment, a drill attachment, etc.). The powerhead unit 102 and the various tool units form a family of powered devices.

The powerhead unit 102 includes a powerhead 110 and a shaft 112 extending along a shaft axis A between the powerhead 110 and a connection portion 114. The powerhead 110 includes a housing 116 defining a compartment containing a motor and other internal components (not shown) of the powerhead 110. The housing 116 may further include a battery attachment portion (not shown) configured to selectively mechanically and electrically connect to a rechargeable battery pack.

In some aspects of the invention, the housing 116 of the powerhead unit 102 also includes a handle 118 supporting a trigger assembly 120 operable to selectively electrically connect the power source (e.g., the battery pack) and the motor. The trigger assembly 120 may include a trigger 122 pivotable about a trigger axis between an un-operated or extended position (an “OFF” position of a control microswitch, not shown) and an operated or depressed position (an “ON” position of the control microswitch, not shown). The trigger assembly 120 may form a user control member for controlling a tool unit 104 coupled to the powerhead unit 102.

The powerhead unit 102 may further include a grip assembly 130. The grip assembly 130 may be coupled to the shaft 112. For instance, as shown in FIG. 1, the grip assembly may be disposed between the powerhead 110 and the connection portion 114. The grip assembly 130 may include a handle, grip, shaft, or other suitable extension for a user to grip and hold the outdoor tool 100 to directionally guide movement of the tool 100.

The connection portion 114 may include an opening (not shown) at a distal end of the shaft 112 configured to receive a connector of the tool unit 104. The connection portion 114 may further include a fastener, e.g., a clamping bolt having a threaded shaft, that may extend through a radial aperture (not shown) of the shaft 112 at the connection portion 114 and a radial aperture (not shown) of the connector of the tool unit 104 to releasably couple the powerhead shaft 112 and the tool unit 102.

The tool unit 102 illustrated in FIG. 1 is an auger, e.g., for digging holes. Specifically, the auger may be designed for digging relative small-diameter holes for planting flowers, grasses, and the like, while the user of the tool 100 remains in a standing position. In this manner, the outdoor tool 100 may provide an ergonomically enhanced tool for digging garden holes by enabling a gardener to dig holes while standing, preventing strain on the gardener's back and joints.

The auger 102 includes a shaft 150 extending from a proximal end 152 to a distal end 154, and a cutting element 160. A connector 156 may be provided at the proximal end 152. The connector 156 is complementary to the connection portion 114 of the tool unit 102 and is configured to be received by the connection portion 114. Moreover, the connector 156 is configured to enable rotation of the shaft 150 driven by rotation of the motor of the powerhead 110.

The cutting element 160 extends radially outward from an outer surface of the shaft 150. In some aspects of the invention, as illustrated in FIG. 1, the cutting element 160 extends in a helical direction along a length of the shaft 150. For instance, the cutting element 160 may extend at least a portion of a length of the shaft 150 between the proximal end 152 and the distal end 154. At least a portion of the shaft 150 between the cutting element 160 and the connector 156 may be free from any portion of the cutting element 160. A handle 158 may be provided along the shaft 150 between the connector 156 and the cutting element 160 to provide a grip for a user to safely hold the tool unit 104, e.g., when coupling or uncoupling the tool unit 104 from the powerhead unit 102. As shown in FIG. 1, the handle 158 may be formed from a cutout or cutaway portion of the shaft 150 to enable a user a designated ergonomic area to safely grip the tool unit 102. However, the present inventors contemplate any suitable handle 158 may be formed with the shaft 150, including a handle extending from the shaft 150.

The shaft 150 may have a generally circular cross-sectional shape along its length, i.e., may be generally cylindrical. The distal end 154 of the shaft 150 may have a different cross-sectional shape than the length of the shaft 150. For instance, the distal end 154 of the shaft 150 may include a pointed or twisted end 162 configured to initiate contact with a ground surface when a user begins a digging operation with the outdoor tool 100. The pointed or twisted end may be formed in any suitable manner to form a digging end. For instance, the pointed or twisted end may be formed by a single piece with the shaft 150, such as by modifying an end of the shaft 150 by sharpening, twisting, or removing a portion of the circumference of the shaft 150. Additionally or alternatively, a twisted or pointed attachment may be coupled to the distal end 154 of the shaft 150.

The cutting element 160 may be formed as a helical shape (having a helical profile) along a length of the shaft 150. For instance, the cutting element 160 may extend to the distal end 154 of the shaft 150 or may be spaced from the distal end 154 of the shaft 150. The cutting element 160 may have a generally circular cross-sectional shape when viewed along the axis A. The cutting element 160 may have a diameter D that generally corresponds to a desired minimum hole diameter. The diameter D may be in a range from about 1 inch to about 8 inches, such as from about 2 inches to about 6 inches. Additionally, the tool unit 102 may have a length L corresponding to a maximum hole depth of the auger. The length L2 may be in a range from about 6 inches to about 36 inches. Regardless of the length L2 of the maximum hole depth of the auger, the shaft 150 may have a length L1 in a range from about 24 inches to about 48 inches. The length L1 of the shaft 150 of the tool unit 104 is designed to be sufficiently long to enable a user to dig a hole using the auger while remaining in a standing position. In other words, a composite length of the powerhead unit 102 and the tool unit 104, along with the positioning of the user control assembly, must be arranged to enable the user to dig a hole using the auger without bending or hinging at the hips, knees, or back.

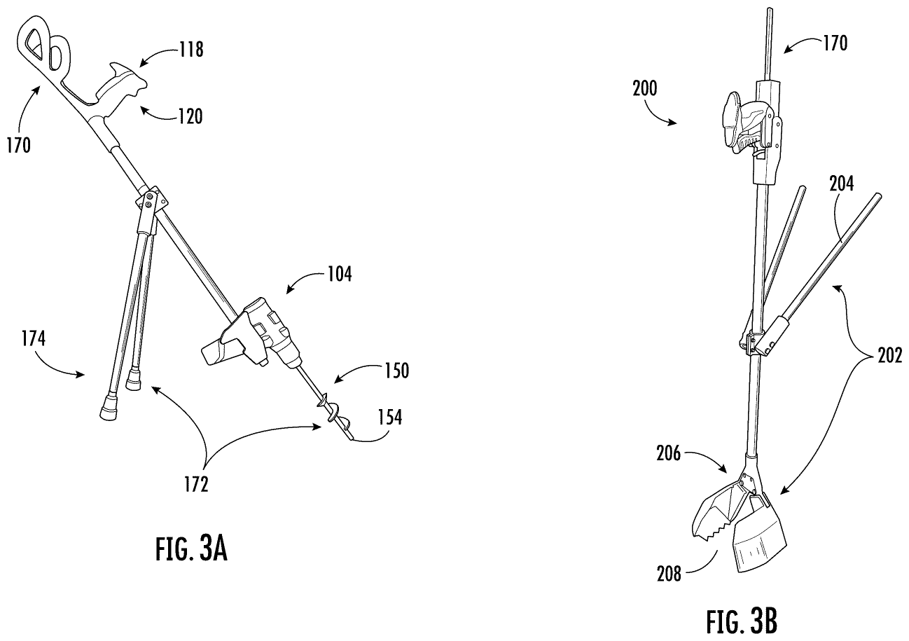

In some aspects of the present invention, the tool 100 may further include a support 170 configured to support a part of a user's upper extremity, i.e., arm, to provide further enhanced ergonomic design to the tool 100. For instance, as illustrated in FIGS. 3A-3B, the trigger assembly 120 may be provided on a joystick-type handle 118 and a support may extend proximally from the handle 118 to support a user's forearm.

In some aspects of the present invention, as shown further in FIG. 3A-3B, the tool 100 may be provided with a ground support assembly 172 configured to enable the tool 100 to balance in an upright or standing position. IN this manner, the user may not need to bend over to pick up the tool 100 off the ground, floor, or other support surface; instead, the tool 100 may remain in a standing position for easy access. The ground support assembly 172 may include a pair of legs 174. When the distal end 154 of the auger and the pair of legs 174 are each in contact with the ground surface, the tool 100 may stand on its own using those three points of contact, similarly to a tripod. In other aspects of the invention, the ground support assembly may include three legs 174 instead of a pair, such that the legs may fully support the tool 100 without requiring the distal end 154 of the shaft 150 as one of the points of contact.

Similarly to the tool 100 illustrated in FIG. 3, the present invention further contemplates a standing planting tool 200 configured to stand upright via a ground support assembly 202 including legs 204 and a planting end 206. The planting end 206 may include a pair of pivotable fingers 208 configured to articulate in a direction towards and away from each other. For instance, a user control handle 210 may include a push button or other control that is coupled, e.g., by a cable or other mechanical or electronic mechanism, to the fingers 208. A user may grasp a plant by articulating the fingers 208 towards each other with the plant between the fingers 208, place the plant in a desired position (e.g., a hole, such as a hole dug by the auger disclosed above), and release the plant in place by articulating the fingers 208 away from each other. In this manner, a user may plant vegetation in the ground without being required to repetitively bend over and stand up.

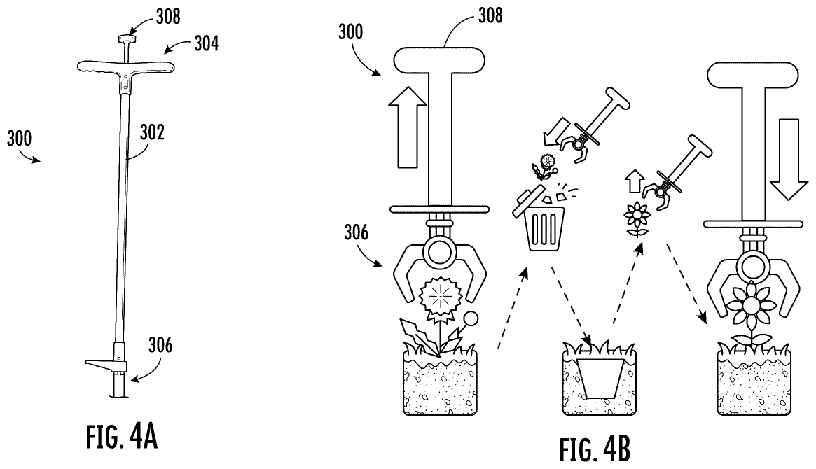

The present disclosure further contemplates a gardening tool 300 that may be configured to both remove vegetation from the ground and place or plant vegetation in the ground, both while the user may remain in a standing position. The tool 300 may include a shaft 302, a handle 304 at a proximal end of the shaft, and a vegetation tool 306 at the distal end of the shaft. The vegetation tool 306 may include a pronged fork or pincers having articulating movement relative to one another. The gardening tool 300 may further include an actuator 308 at the handle 304, such as a push/pull button as illustrated in FIGS. 4A-4B. As illustrated in FIG. 4B, when the actuator 308 is actuated toward the proximal direction, i.e., pulled toward the user, the vegetation tool 306 may be activated to grasp or pull at vegetation with which it is in contact—in other words, may pull a weed or other vegetation from the ground. To remove the vegetation from the vegetation tool 306, the actuator 308 may be actuated towards the distal end, i.e., away from the user. In an opposite action, to place a desired plant into the ground, a user may actuate the vegetation tool 306 to grip the dirt of the desired plant by actuating the actuator 308 in the proximal direction, place the desired plant in the desired position, and release the actuator in the distal direction to leave the plant in the desired position.

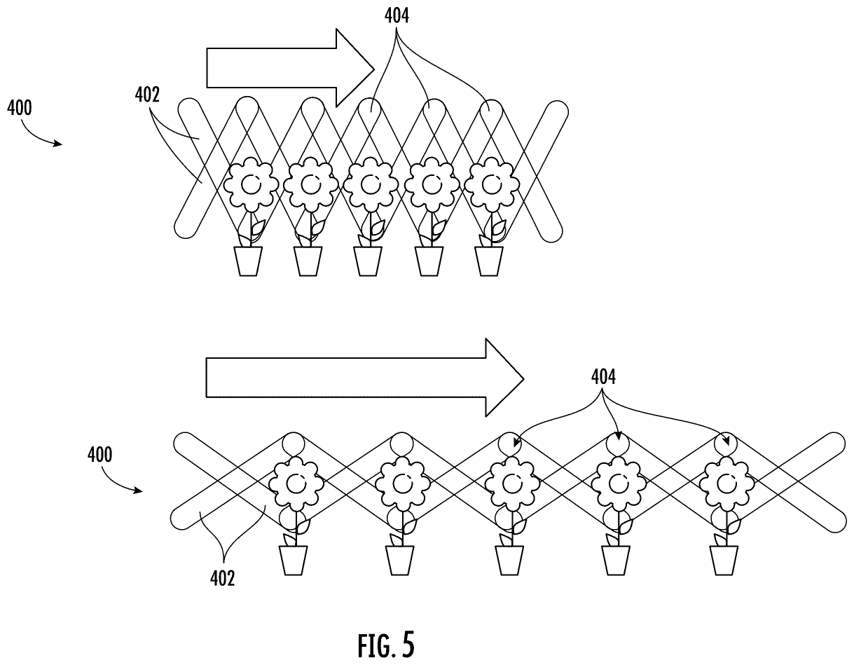

The present disclosure further contemplates a tool for measuring the spacing of vegetation in uniform lines. As illustrated in FIG. 5, the spacing tool 400 may be formed as a scissor or accordion spacer comprising a plurality of elements 402 hingedly coupled together at joints 404. The elements 402 can be extended or collapsed relative to each other in a horizontal direction, much like the bellows of an accordion. The spacing tool 400 may have a minimum length, when the elements 402 are aligned together as close as possible, and a maximum length, when the joints 404 are spaced apart as far as possible. As each element 402 has a constant length, each of the joints 404 may be spaced apart at equal intervals. A user may align the vegetation to be planted along each of the joints 404 to space out the vegetation uniformly and in a linear manner. Thus, instead of measuring each plant's position or “eye-balling” plant alignment, a user can quickly and confidently space out the plants prior to planting, saving time and improving efficiency during the gardening process.

Further aspects of the disclosure are provided by one or more of the following embodiments:

An outdoor tool comprising: a powerhead; a user control member; a grip member; a tool unit powered by the powerhead; the tool unit comprising: an elongated body comprising a shaft and a cutting element extending radially from the shaft, and a connector, the connector configured to couple with a complementary connector of the powerhead, wherein the tool unit is configured to be rotatably driven by the powerhead.

The outdoor tool of any one or more of the embodiments, wherein the user control member is disposed on the grip member.

The outdoor tool of any one or more of the embodiments, wherein the user control member and the grip member are spaced apart.

The outdoor tool of any one or more of the embodiments, further comprising a support assembly configured to support the outdoor tool in a generally upright standing position with an end of the tool unit in contact with a support surface.

The outdoor tool of any one or more of the embodiments, wherein the support assembly comprises a pair of legs.

The outdoor tool of any one or more of the embodiments, wherein the support assembly is configured to be moved between a support position in which the support assembly supports the outdoor tool in the generally upright standing position with the end of the tool unit in contact with the support surface, and a collapsed position.

The outdoor tool of any one or more of the embodiments, wherein the powerhead and the tool unit are removably coupled.

The outdoor tool of any one or more of the embodiments, wherein the tool unit has a maximum length in a range from about 24 inches to 48 inches.

The outdoor tool of any one or more of the embodiments, wherein the outdoor tool has a maximum length configured to allow a user to dig a hole in a ground surface when the user is in a standing position.

The outdoor tool of any one or more of the embodiments, wherein the cutting element extends around the shaft in a helical direction.

The outdoor tool of any one or more of the embodiments, wherein the cutting element is spaced apart from both the connector of the tool unit and a distal end of the shaft opposite the connector.

The outdoor tool of any one or more of the embodiments, wherein a distal end of the shaft opposite the connector comprises a pointed and/or a helical profile configured to initiate digging a hole when the tool unit is rotated.

The outdoor tool of any one or more of the embodiments, wherein the cutting element is spaced apart from the distal end of the shaft.

The outdoor tool of any one or more of the embodiments, wherein the outdoor tool is configured to dig a hole in a ground surface, the maximum depth of the hole corresponding to a length extending from a distal end of the shaft opposite the connector to an end of the cutting element proximate the connector.

The outdoor tool of any one or more of the embodiments, further comprising a grip section disposed on the shaft of the tool unit.

The outdoor tool of any one or more of the embodiments, wherein the grip section comprises a cutaway portion of the shaft between the connector and the cutting element.

The outdoor tool of any one or more of the embodiments, wherein the powerhead comprises a motor and a power source disposed at an opposite end of the powerhead relative to the complementary connector of the powerhead.

The outdoor tool of any one or more of the embodiments, wherein the complementary connector of the powerhead is configured to interchangeably receive the tool unit and at least one second tool unit, the second tool unit selected from the group consisting of a string trimmer, a pole saw, a hedge trimmer, an edger, a brush cutter, a blower, a broom, and a brush.

An outdoor tool comprising: a shaft, a handle at an end of the shaft, a tool at an opposite end of the shaft, the tool comprising at least two elements pivotally coupled together, and an actuator disposed proximate to the handle, wherein actuation of the actuator in a first direction causes the at least two elements to pivot closer together, and actuation of the actuator in a second direction opposite the first direction causes the at least two elements to pivot away from each other; wherein the tool is adapted for removing vegetation from the ground and/or for grasping and placing vegetation into the ground.

This written description uses examples to disclose the present application, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An outdoor tool comprising: a powerhead; a user control member; a grip member; a tool unit powered by the powerhead; the tool unit comprising: an elongated body comprising a shaft and a cutting element extending radially from the shaft, and a connector, the connector configured to couple with a complementary connector of the powerhead, wherein the tool unit is configured to be rotatably driven by the powerhead.

2. The outdoor tool of claim 1, wherein the user control member is disposed on the grip member.

3. The outdoor tool of claim 1, wherein the user control member and the grip member are spaced apart.

4. The outdoor tool of claim 1, further comprising a support assembly configured to support the outdoor tool in a generally upright standing position with an end of the tool unit in contact with a support surface.

5. The outdoor tool of claim 4, wherein the support assembly comprises a pair of legs.

6. The outdoor tool of claim 4, wherein the support assembly is configured to be moved between a support position in which the support assembly supports the outdoor tool in the generally upright standing position with the end of the tool unit in contact with the support surface, and a collapsed position.

7. The outdoor tool of claim 1, wherein the powerhead and the tool unit are removably coupled.

8. The outdoor tool of claim 1, wherein the tool unit has a maximum length in a range from about 24 inches to 48 inches.

9. The outdoor tool of claim 1, wherein the outdoor tool has a maximum length configured to allow a user to dig a hole in a ground surface when the user is in a standing position.

10. The outdoor tool of claim 1, wherein the cutting element extends around the shaft in a helical direction.

11. The outdoor tool of claim 1, wherein the cutting element is spaced apart from both the connector of the tool unit and a distal end of the shaft opposite the connector.

12. The outdoor tool of claim 1, wherein a distal end of the shaft opposite the connector comprises a pointed and/or a helical profile configured to initiate digging a hole when the tool unit is rotated.

13. The outdoor tool of claim 12, wherein the cutting element is spaced apart from the distal end of the shaft.

14. The outdoor tool of claim 1, wherein the outdoor tool is configured to dig a hole in a ground surface, the maximum depth of the hole corresponding to a length extending from a distal end of the shaft opposite the connector to an end of the cutting element proximate the connector.

15. The outdoor tool of claim 1, further comprising a grip section disposed on the shaft of the tool unit.

16. The outdoor tool of claim 15, wherein the grip section comprises a cutaway portion of the shaft between the connector and the cutting element.

17. The outdoor tool of claim 1, wherein the powerhead comprises a motor and a power source disposed at an opposite end of the powerhead relative to the complementary connector of the powerhead.

18. The outdoor tool of claim 1, wherein the complementary connector of the powerhead is configured to interchangeably receive the tool unit and at least one second tool unit, the second tool unit selected from the group consisting of a string trimmer, a pole saw, a hedge trimmer, an edger, a brush cutter, a blower, a broom, and a brush.

19. An outdoor tool comprising: a shaft, a handle at an end of the shaft, a tool at an opposite end of the shaft, the tool comprising at least two elements pivotally coupled together, and an actuator disposed proximate to the handle, wherein actuation of the actuator in a first direction causes the at least two elements to pivot closer together, and actuation of the actuator in a second direction opposite the first direction causes the at least two elements to pivot away from each other; wherein the tool is adapted for removing vegetation from the ground and/or for grasping and placing vegetation into the ground.
